(19) United States
(12) Patent Application Publication
(10) Pub. No.: US 2010/0088471 A1
(43) Pub. Date: Apr. 8, 2010

(54) FIELD DEVICE

(75) Inventors: Shinichi SUNAGA, Musashino-shi (JP); Hidehiko Wada, Musashino-shi (JP); Noriyuki Hosobuchi, Musashino-shi (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 12/573,403

(22) Filed: Oct. 5, 2009

(30) Foreign Application Priority Data
Oct. 7, 2008 (JP) 2008-260636
Mar. 12, 2009 (JP) 2009-058883

(51) Int. Cl. G06F 12/00; G06F 12/08

(52) U.S. Cl. 711/130; 711/147; 711/E12.017; 711/E12.001

(57) ABSTRACT

Disclosed is a field device comprising: a storage section to store shared data which is shared between user modules; an interface section to obtain trigger information to access the shared data, and to output access information which includes an access content of the shared data and an access request of the shared data, based on the obtained trigger information; and a control section to access the shared data which is stored in the storage section, based on the access information which has been output by the interface section.

### BACKGROUND OF THE INVENTION

1. Field of the Invention

The present invention relates to a field device.

2. Related Art

A field device, such as a flow meter and a thermometer, which includes a sensor, an actuator, and a controller, has been known hitherto.

Here, an example of the configuration of a conventional field device 100 is described with reference to FIG. 20. As shown in FIG. 20, the field device 100 includes a central processing unit (CPU) 111, a read only memory (ROM) 112, a random access memory (RAM) 113, a nonvolatile memory 114, a sensor 115, a communication controller 116, and a display 117. The nonvolatile memory 114, the sensor 115, the communication controller 116, and the display 117 are connected to the CPU 111 through connection interfaces 118. Incidentally, the connection interfaces 118 are supposed to be a bus, a serial interface, and the like, which are different from one another according to each field device 100.

The CPU 111 includes three software modules of a sensor processing module 119, a communication module 120, and a display processing module 121.

The sensor processing module 119 is a module of receiving an interruption from the sensor 115 to read a measured value, and performing various correction operations and the like to calculate a process value and the like.

The communication module 120 is a module of performing field communication. The communication module 120 performs the processing of transmitting a measured value and various set items to another field device by the field communication, and receiving a command from another field device to transmit the received command to a related module. Moreover, the communication module 120 operates by an interruption from the communication controller 116, and spontaneously operates to transmit a command to the communication controller 116.

The display processing module 121 is a module of outputting a command to display a measured value, a warning, and the like on the display 117.

The ROM 112 is a recording medium into which the rewriting of information is impossible. The ROM 112 stores programs to be executed by the CPU 111 and the like.

The RAM 113 is a volatile memory, and forms a work area for temporarily storing various programs to be executed and data (such as global variables and local variables) pertaining to the various programs.

The nonvolatile memory 114 is a memory for storing various set values, such as correction coefficients of the sensor 115, statistical information, and the like (hereinafter referred to as stored data), which are desired to be stored even when a power source is broken.

The sensor 115 is the hardware for detecting physical quantities to be measured by the field device 100.

The communication controller 116 is the hardware having charge of the transmission of signals and the like at the time of performing field communication (Foundation Fieldbus, Profibus-PA, HART communication and the like).

The display 117 is the hardware to display information of a measured value, a warning, and the like, such as a liquid crystal display (LCD).

Each module (the sensor processing module 119, the communication module 120, and the display processing module 121) in the field device 100 having the configuration mentioned above independently operates, mutually referring to and updating the variables (indicating a global variable group 113a and a local variable group 113b in the RAM 113) managed by each module and stored data 114a in the nonvolatile memory 114.

Incidentally, because no prior art document information pertaining prior art to be described could not be obtained, the description of the prior art document information is omitted.

However, in the field device 100, each module mutually refers to and updates the global variable group 113a managed by each module and the stored data 114a in the nonvolatile memory 114. Consequently, the field device 100 has the structure difficult to perform development operations (modification, deletion, replacement, and the like) independently in each module.

For example, while the sensor processing module 119 is performing the modification (writing) of a sensor processing module global variable included in the global variable group 113a, another module (the communication module 120 or the like) can directly refer to (read) the sensor processing module global variable, which is being subjected to the modification. Consequently, an inconsistency between the data of the sensor processing module global variable read by the other module and the data of the sensor processing module global variable after the modification is caused.

Moreover, for example, when the sensor processing module 119 has deleted the sensor processing module global variable, the other modules (the communication module 120 and the like) cannot refer to the deleted sensor processing module global variable. In this case, when the other module needs the sensor processing module global variable, the defect of the impossibility of processing by the other module is caused.

Consequently, when each module independently performs a development operation, the other modules are influenced, and the lowering of the maintenance properties of the modules is caused.

Moreover, for example, when replacement is performed for every module, the other modules are influenced, and consequently it is difficult to divert a module of a certain field device to another field device. In this case, it is necessary to customize the modules having the same function to each type of field buses, and it causes the lowering of the development efficiency of the modules.

### SUMMARY OF THE INVENTION

The present invention is directed to improve the maintenance property and development efficiency of a module.

According to an aspect of the present invention, there is provided a field device comprising:

a storage section to store shared data which is shared between user modules;

an interface section to obtain trigger information to access the shared data, and to output access information which includes an access content of the shared data and an access request of the shared data, based on the obtained trigger information; and

a control section to access the shared data which is stored in the storage section, based on the access information which has been output by the interface section.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram showing an internal configuration of the field device of a first embodiment according to the present invention;

FIG. 2 is a flow chart showing a flow of a sensor calculation processing;

FIG. 3 is another flow chart showing a flow of the sensor calculation processing;

FIG. 4 is a flow chart showing a flow of a set value writing processing;

FIG. 5 is a flow chart showing a flow of an initialization processing;

FIG. 6 is a diagram showing an internal configuration of the field device of a modification of the first embodiment according to the present invention;

FIG. 7 is a diagram showing an internal configuration of the field device of a second embodiment according to the present invention;

FIG. 8A is a diagram showing a variable-reference module list;

FIG. 8B is a diagram showing a reference variable list;

FIG. 9 is a flow chart showing a flow of a registration processing;

FIG. 10 is a flow chart showing a flow of a first event transmitting and receiving processing;

FIG. 11 is another flow chart showing the flow of the first event transmitting and receiving processing;

FIG. 12 is a flow chart showing a flow of a second event transmitting and receiving processing;

FIG. 13 is another flow chart showing the flow of the second event transmitting and receiving processing;

FIG. 14 is a flow chart showing a flow of a third event transmitting and receiving processing;

FIG. 15 is another flow chart showing the flow of the third event transmitting and receiving processing;

FIG. 16 is a diagram showing an internal configuration of the field device of a modification of the second embodiment according to the present invention;

FIG. 17 is a flow chart showing a flow of writing processing;

FIG. 18 is a flow chart showing a flow of a fourth event transmitting and receiving processing;

FIG. 19 is another flow chart showing the flow of the fourth event transmitting and receiving processing; and

FIG. 20 is a diagram showing an internal configuration of the conventional field device.

### DETAILED DESCRIPTION OF THE PREFERRED EMBODIMENTS

In the following, the preferred embodiments of the present invention will be described in detail with reference to the attached drawings. However, the scope of the present invention is not limited to the shown examples.

### First Embodiment

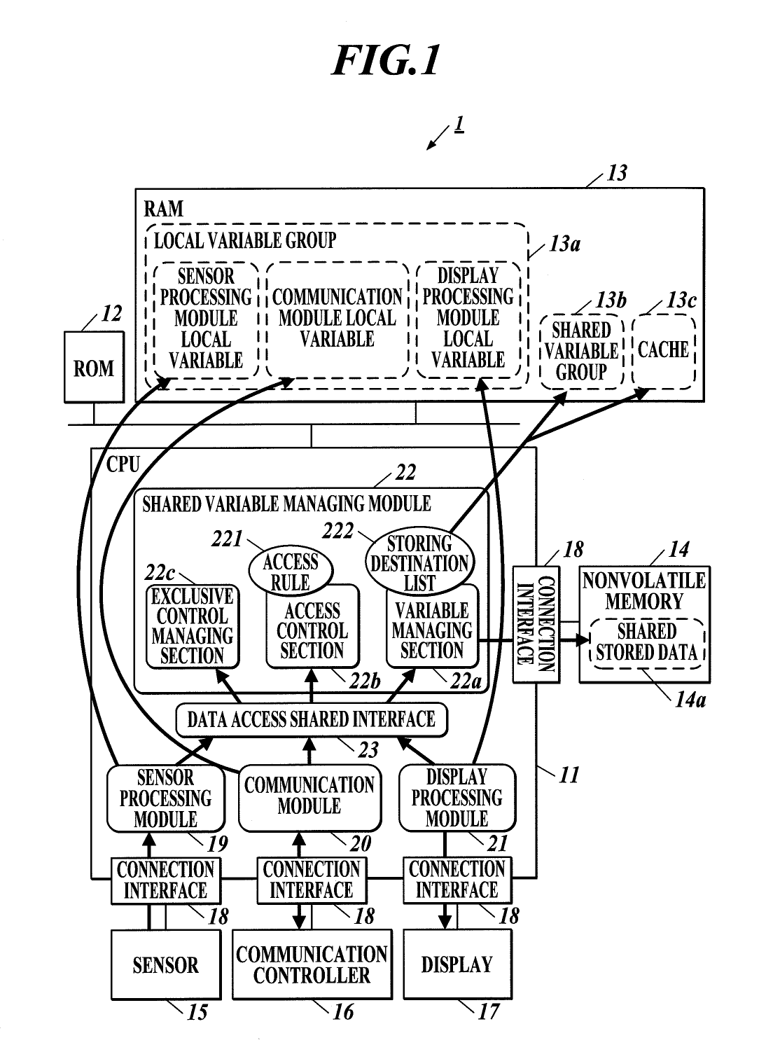

A first embodiment of the present invention will be described with reference to FIGS. 1-5. A field device 1 of the present embodiment includes a CPU 11, a ROM 12, a RAM 13 as a storage section, a nonvolatile memory 14 as the storage section, a sensor 15, a communication controller 16, a display 17, and connection interfaces 18 as a communication section. The CPU 11, the ROM 12, the RAM 13, the nonvolatile memory 14, the sensor 15, the communication controller 16, the display 17, and the connection interfaces 18 have the configurations similar to the CPU 111, the ROM 112, the RAM 113, the nonvolatile memory 114, the sensor 115, the communication controller 116, the display 117, and the connection interfaces 118 of the field device 100, respectively. In the following, the parts of the field device 1 different from those of the field device 100 will be chiefly described.

The CPU 11 includes a sensor processing module 19, a communication module 20, a display processing module 21, a shared variable managing module 22 as a control section, and a data access shared interface 23 as an interface section.

To put it concretely, the data access shared interface 23 of the CPU 11 obtains trigger information for accessing shared data (shared variables stored in the shared variable group 13b, cache data stored in a cache 13c, and shared stored data 14a stored in the nonvolatile memory 14) in cooperation with a sensor operation program, a set value changing program, and an initialization program, which will be described later. Then, the data access shared interface 23 of the CPU 11 outputs access information including access content and an access request to the shared variable managing module 22 on the basis of the obtained trigger information. Then, the shared variable managing module 22 of the CPU 11 accesses the shared data on the basis of the output access information.

Incidentally, the output trigger information may be obtained by the data access shared interface 23 by a spontaneous operation of a user module (the operation of the user module to spontaneously output the trigger information to the data access shared interface 23). For example, the display processing module 21 may spontaneously output the trigger information for periodically accessing the shared data (process value) to the data access shared interface 23. In this case, the data access shared interface 23 obtains the trigger information and outputs access information to the shared variable managing module 22 on the basis of the obtained trigger information. Then, the shared variable managing module 22 accesses the shared data on the basis of the access information. Then, the display processing module 21 obtains the accessed shared data through the data access shared interface 23. Then, the display processing module 21 outputs a display request based on the shared data to the display 17.

The sensor processing module 19, the communication module 20, and the display processing module 21 perform the operations similar to those of the sensor processing module 119, the communication module 120, and the display processing module 121 of the field device 100, respectively. In the present embodiment, the shared data referred to by each user module (the sensor processing module 19, the communication module 20, and the display processing module 21) is the shared variables stored in the shared variable group 13b managed by a variable managing section 22a of the shared variable managing module 22, the cache data stored in the cache 13c, or the shared stored data 14a. Accordingly, each user module accesses the shared variables stored in the shared variable group 13b managed by the shared variable managing module 22, the cache data stored in the cache 13c, or the shared stored data 14a through the data access shared interface 23. Moreover, as for a local variable group 13a (sensor processing module local variables, communication module local variables, and display processing module local variables), which is used only in each module, each module directly accesses the local variable group 13a in the RAM 13 similarly to that of the field device 100.

The shared variable managing module 22 is software operating on the CPU 11, and includes the sub modules of the variable managing section 22a, an access control section 22b, an exclusive control managing section 22c as a shared data managing section.

The variable managing section 22a manages the shared variables stored in the shared variable group 13b in the RAM 13, the cache data stored in the cache 13c, or the shared stored data 14a in the nonvolatile memory 14, and performs access in response to a request from the user module (the sensor processing module 19, the communication module 20, and the display processing module 21). The shared variable group 13b stores volatile data, which causes no hindrance even when the volatile data disappears at the time of a power source break. The cache 13c stores the same data (cache data) as the shared stored data 14a.

Moreover, the variable managing section 22a accesses a shared variable stored in the shared variable group 13b, cache data stored in the cache 13c, or the shared stored data 14a when a user module requests the data. At this time, the variable managing section 22a accesses the shared variable stored in the shared variable group 13b, the cache data stored in the cache 13c, or the shared stored data 14a on the basis of a storing destination list 222 describing the areas (storing places) where each shared data is stored. Here, when the variable managing section 22a reads volatile data, the variable managing section 22a reads the volatile data from the shared variable group 13b. When the variable managing section 22a reads nonvolatile data, the variable managing section 22a reads the nonvolatile data from the cache 13c. Moreover, when the variable managing section 22a writes volatile data, the variable managing section 22a writes the volatile data into the shared variable group 13b. When the variable managing section 22a writes nonvolatile data, the variable managing section 22a writes the nonvolatile data into the cache 13c and the shared stored data 14a.

Moreover, because no data is stored in the cache 13c at the time of start-up, the variable managing section 22a copies the shared stored data 14a to the cache 13c at the time of the initialization of the shared variable managing module 22.

The access control section 22b checks whether a right user module performs access by a right access method (reading or writing) or not in conformity with an access rule 221 when the user module performs an access request to shared data.

The access rule 221 describes access rights to shared data. To put it concretely, the access rule 221 describes the identifier (identification information) of shared data and the access right (reading enable, writing enable, access disable, and the like) of each user module. For example, when a value is tried to be written into a variable “a” from the sensor processing module 19 in the state in which the sensor processing module 19 has the authority only of reading the variable “a”, the access is discontinued. By this function, the unrighteous access to shared data can be detected. The check of access is performed for every access to shared data.

The exclusive control managing section 22c has the function of controlling a plurality of independently operating user modules so as not to access the shared data in process of updating when the plurality of user modules access the same shared data at the same time.

Moreover, when the exclusive control managing section 22c tries to access a plurality of pieces of shared data at the same time, the exclusive control managing section 22c accesses the plurality of pieces of shared data at the same timing. The exclusive control managing section 22c performs the simultaneous access in the case of accessing, for example, the shared data that is significant only in a set of data being at the same time, such as the value of a measured value and the state thereof.

Moreover, when the exclusive control managing section 22c accesses the shared data managed by the variable managing section 22a, the exclusive control managing section 22c automatically performs exclusive control.

The data access shared interface 23 is a module to be used for the modules that a developer develops, such as the sensor processing module 19, the communication module 20, and the display processing module 21, when the modules access a shared variable stored in the shared variable group 13b, which is shared by each of the modules, the cache data stored in the cache 13c, or the shared stored data 14a.

To put it concretely, the data access shared interface 23 obtains trigger information from the outside through the connection interfaces 18, or obtains the trigger information output by a spontaneous operation of a user module. Then, the data access shared interface 23 outputs on the basis of the obtained trigger information an exclusive access control request of shared data (such as the exclusive access control request of a process value and a status value), the access content of the shared data (for example, when the shared data to be accessed is a shared variable, the information of the shared variable and an access method), and an access request of the shared data (such as a request to write the process value and the status value into the shared variable group 13b, and the like).

Moreover, the data access shared interface 23 includes four functions of “reading the value of a shared data,” “writing the value of a shared data,” “reading the values of a plurality of shared data,” and “writing the values of a plurality of shared data” as the functions thereof. For example, in case of reading a plurality of shared data at a time, in case of writing a plurality of shared data at a time, in case of reading a plurality of shared data at a certain time point, in case of updating a plurality of shared data at the same time, or the like, the data access shared interface 23 includes the functions of “reading the values of a plurality of shared data,” and “writing the values of the plurality of shared data.”

The RAM 13 stores the local variable group 13a, the shared variable group 13b, and the cache 13c. Local variables used only in each module are stored in the local variable group 13a. Shared variables shared by each module and each user module are stored in the shared variable group 13b. The cache data of the shared stored data shared by each user module is stored in the cache 13c.

Incidentally, the shared variable group 13b, the shared stored data 14a, the access rule 221, and the storing destination list 222 are different in each field device 1 to be developed, and accordingly a developer sets them at the time of designing them with a tool.

To put it concretely, the developer creates a set file describing the list of shared data to be used (shared variables constituting the shared variable group 13b, local variables constituting the local variable group 13a, the shared stored data 14a, and the like) to each module to be developed.

At this time, a shared data name, the information indicating an access method, and volatile information are set to each shared data. The shared data name is the name of shared data. For example, the variable name of a shared variable is set as the shared data name. The information indicating the access method is the data indicating the access authority of the own module. For example, as the information indicating the access method, “only reading,” “only writing,” “both of reading and writing,” or the like is set. The volatile information is the information for identifying whether shared data is volatile data or not. For example, as the volatile information, “the data may disappear at the time of power source break,” “the data is desired to be held even when the power source is turned off,” and the like are set.

Then, the set set file is applied to a tool. At this time, the tool extracts the shared variable group 13b, the shared stored data 14a, and the like, and generates the source code of the shared variable group 13b in the RAM 13, the source code of the shared stored data 14a in the nonvolatile memory 14, the source code of the cache 13c in the RAM 13, the storing destination list 222 (source code), and the access rule 221 (source code). The generated source code is incorporated in the variable managing section 22a or the access control section 22b.

The connection interfaces 18 receives the trigger information for accessing the shared data (an interruption indicating the completion of the preparation of a measured value in the sensor 15, a set value changing request for writing a set value from the communication controller 16, electric power to be supplied to the CPU 11 for reading an initialization variable, and the like).

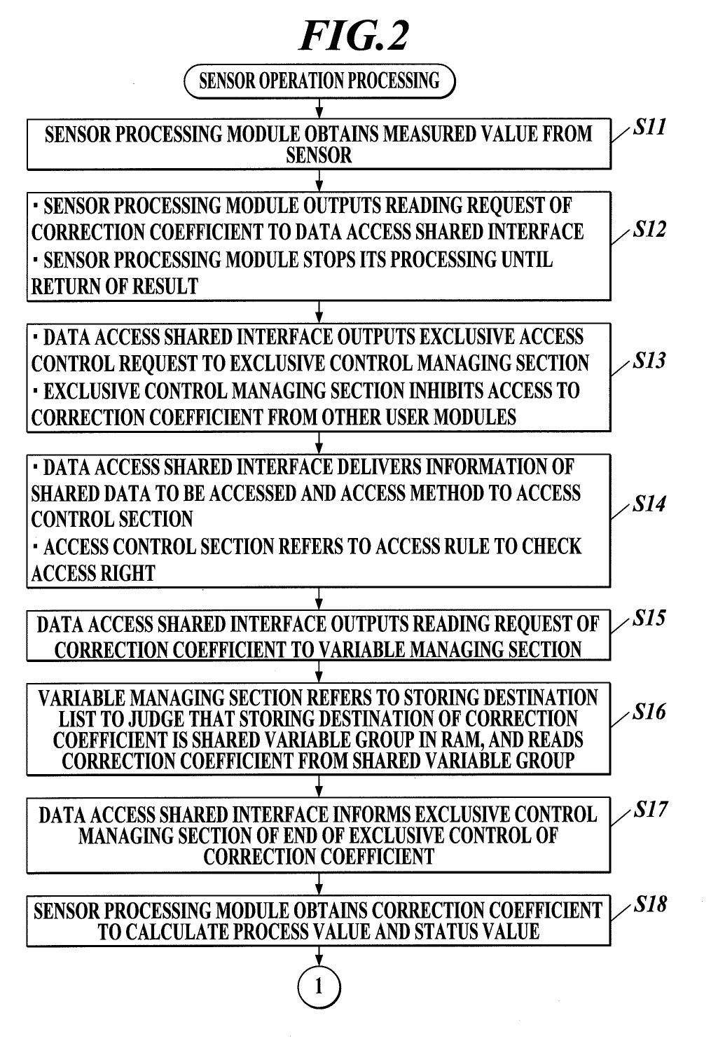

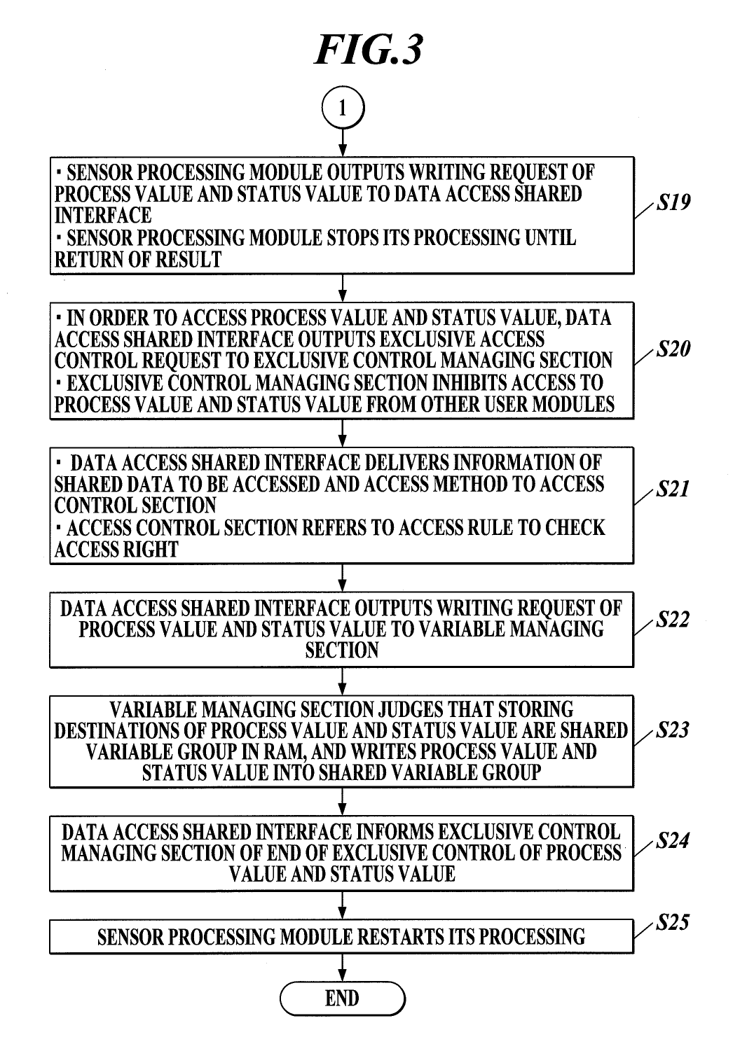

Next, the operation of the field device 1 will be described with reference to FIGS. 2-5. First, sensor operation processing will be described with reference to FIGS. 2 and 3. The sensor operation processing is the processing of calculating a process value and the state value at that time from a value measured by the sensor 15 and a correction coefficient, which is the volatile data held by the shared variable group 13b in the RAM 13 to write the calculated process value and the state value into the shared variable group 13b in the RAM 13.

It is supposed that the reading and the writing of the process values and the status values from the sensor processing module 19 and the reading of the correction coefficients from the sensor processing module 19 are permitted in advance. Moreover, it is supposed that the correction coefficients are stored in the shared variable group 13b in the RAM 13.

For example, in the field device 1, an interruption (the interruption indicating the completion of the preparation of a measured value in the sensor 15) from the sensor 15 is received by the connection interface 18, and sensor operation processing is executed with the cooperation between the sensor operation program, which is read from the ROM 12 and is suitably expanded in the RAM 13, and the CPU 11 by the entering of the received interruption into the sensor processing module 19 as a trigger.

First, the sensor processing module 19 obtains a measured value from the sensor 15 (Step S11). Then, the sensor processing module 19 outputs a reading request of a correction coefficient to the data access shared interface 23. Here, the sensor processing module 19 stops its processing until the return of a result (Step S12).

After the execution of the processing at Step S12, in order to access the correction coefficient, the data access shared interface 23 outputs an exclusive access control request to the exclusive control managing section 22c. Then, the exclusive control managing section 22c inhibits the correction coefficient from being accessed from the other user modules (Step S13).

Then, the data access shared interface 23 delivers the information of the shared data (correction coefficient) to be accessed and an access method (reading) to the access control section 22b. Then, the access control section 22b refers to the access rule 221 to check an access right (Step S14). In this example, the access control section 22b returns the fact of being accessible (access OK) to the data access shared interface 23.

After the execution of the processing at Step S14, the data access shared interface 23 outputs a reading request of the correction coefficient to the variable managing section 22a (Step S15). Then, the variable managing section 22a refers to the storing destination list 222 to judge that the storing destination of the correction coefficient is the shared variable group 13b in the RAM 13, and the variable managing section 22a reads the data from the shared variable group 13b (Step S16).

After the execution of the processing at Step S16, the data access shared interface 23 informs the exclusive control managing section 22c of the end of the exclusive control of the correction coefficient (Step S17). Then, the sensor processing module 19 restarts its processing stopped at the execution of the processing at Step S12, and the sensor processing module 19 obtains the correction coefficient. Then, the sensor processing module 19 accesses a sensor processing module local variable in the local variable group 13a, and at the same time the sensor processing module 19 performs its processing by using the obtained correction coefficient to calculate the process value and the status value of the sensor (Step S18).

After the execution of the processing at Step S18, the sensor processing module 19 outputs the writing request of the process value and the status value calculated at Step S18 to the data access shared interface 23. At this time, the sensor processing module 19 stops its processing until the return of a result (Step S19). Then, in order to access the process value and the status value, the data access shared interface 23 outputs an exclusive access control request to the exclusive control managing section 22c. Then, the exclusive control managing section 22c inhibits the process value and the status value from being accessed from the other user modules (Step S20).

After the execution of the processing at Step S20, the data access shared interface 23 delivers the information of the shared data (process value and status value) to be accessed and an access method (writing) to the access control section 22b. Then, the access control section 22b refers to the access rule 221 to check the access right (Step S21). In this example, the access control section 22b returns the fact of being accessible (access OK) to the data access shared interface 23.

After the execution of the processing at Step S21, the data access shared interface 23 outputs a writing request of the process value and the status value to the variable managing section 22a (Step S22). Then, the variable managing section 22a refers to the storing destination list 222 to judge that the storing destinations of the process value and the status value are the shared variable group 13b in the RAM 13, and writes the process value and the status value into the shared variable group 13b (Step S23).

After the execution of the processing at Step S23, the data access shared interface 23 informs the exclusive control managing section 22c of the end of the exclusive control of the process value and the status value (Step S24). Then, the sensor processing module 19 restarts its processing stopped at the processing at Step S19 (Step S25). After the execution of the processing at Step S25, the sensor operation processing ends.

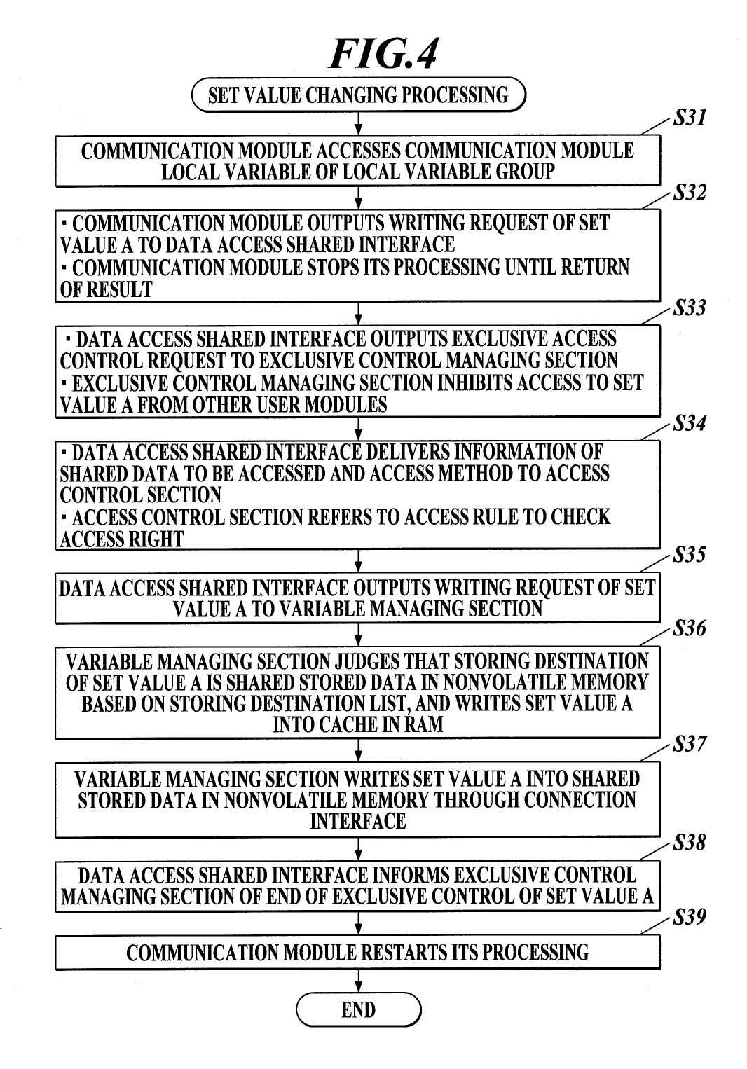

Next, set value changing processing will be described with reference to FIG. 4. The set value changing processing is the processing of writing a set value (hereinafter referred to as a set value A) into the cache 13c in the RAM 13 and the shared stored data 14a of the nonvolatile memory 14 on the basis of a change request transmitted from the communication controller 16.

It is supposed that the set value A has been stored in the shared stored data 14a in the nonvolatile memory 14 in advance. Moreover, it is supposed that the reading and the writing of the set value A from the communication module 20 is permitted.

For example, the set value changing processing is executed in the field device 1 with the cooperation between the set value changing program, which is read from the ROM 12 and is suitably expanded in the RAM 13, and the CPU 11 by the entering of a change request of the set value A, which is received from the communication controller 16 through the connection interface 18, into the communication module 20 as a trigger.

First, the communication module 20 accesses the communication module local variable in the local variable group 13a (Step S31). Then, the communication module 20 outputs a writing request of the set value A to the data access shared interface 23. At this time, the communication module 20 stops its processing until the return of a result (Step S32).

After the execution of the processing at Step S32, in order to access the set value A, the data access shared interface 23 outputs an exclusive access control request to the exclusive control managing section 22c. Then, the exclusive control managing section 22c inhibits the set value A from being accessed from the other user modules (Step S33). Then, the data access shared interface 23 delivers the information of the shared data (set value A) to be accessed and an access method (writing) to the access control section 22b. Then, the access control section 22b refers to the access rule 221 to check the access right (Step S34). In this example, the access control section 22b returns the fact of being accessible to the data access shared interface 23 (access OK).

After the execution of the processing at Step S34, the data access shared interface 23 outputs a writing request of the set value A to the variable managing section 22a (Step S35). Then, the variable managing section 22a refers to the storing destination list 222 to judge that the storing destination of the set value A is the shared stored data 14a in the nonvolatile memory 14, and the variable managing section 22a writes the set value A into the cache 13c in the RAM 13 (Step S36).

After the execution of the processing at Step S36, the variable managing section 22a writes the set value A into the shared stored data 14a in the nonvolatile memory 14 through the connection interface 18 (Step S37). Then, the data access shared interface 23 informs the exclusive control managing section 22c of the end of the exclusive control of the set value A (Step S38). Then, the communication module 20 restarts its processing stopped by the processing at Step S32 (Step S39). After the execution of the processing at Step S39, the set value changing processing ends.

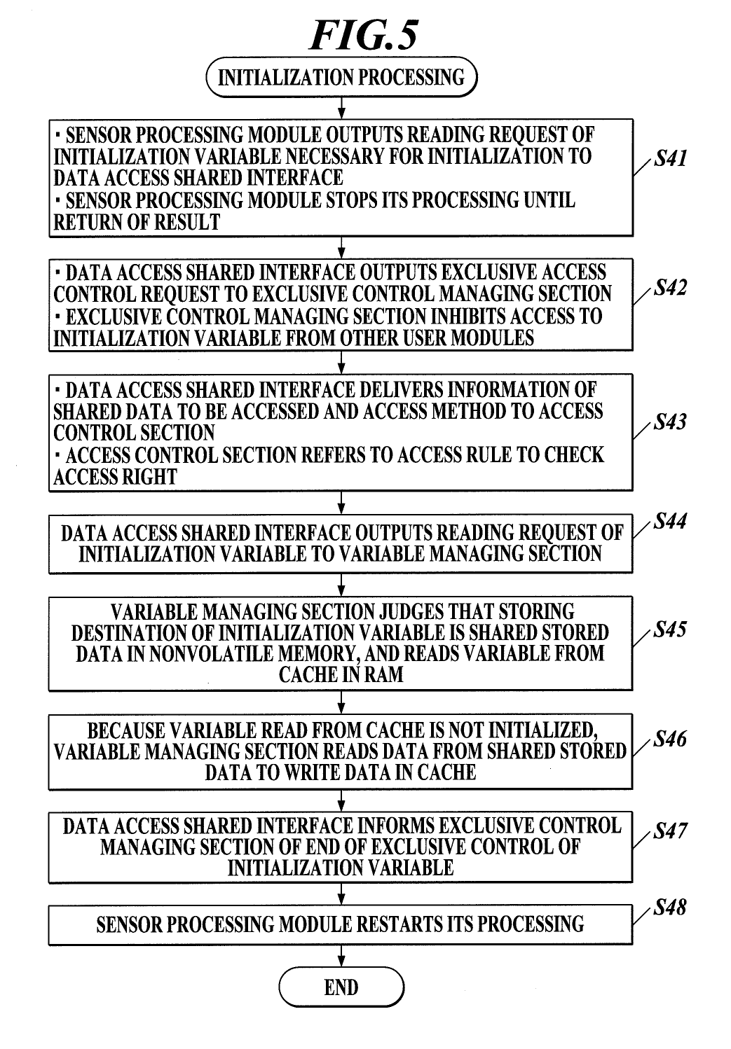

Next, initialization processing will be described with reference to FIG. 5. The initialization processing is the processing to write the initialization data of the sensor processing module 19 in to the cache 13c and the shared stored data 14a of the nonvolatile memory 14.

It is supposed that the initialization data is stored in the shared stored data 14a in the nonvolatile memory 14 in advance. Moreover, it is supposed that the reading and writing of the set value A from the sensor processing module 19 is permitted.

For example, in the field device 1, the initialization processing is executed with the cooperation between the initialization program, which is read from the ROM 12 and is suitably expanded in the RAM 13, and the CPU 11 by the reception of the electric power supplied from the power source section (not shown) through the connection interface 18, the entering of the received electric power into the CPU 11 to electrify the CPU 11, and the starting of the initialization of the sensor processing module 19 after the electrification of the CPU 11 as a trigger.

First, the sensor processing module 19 outputs a reading request of the initialization data (initialization variable) necessary for initialization to the data access shared interface 23. The sensor processing module 19 stops its processing until the return of a result (Step S41). Then, in order to access the initialization variable, the data access shared interface 23 outputs an exclusive access control request to the exclusive control managing section 22c. Then, the exclusive control managing section 22c inhibits the initialization variable from being accessed by the other user modules (Step S42).

After the execution of the processing at Step S42, the data access shared interface 23 delivers the information of the shared data (initialization variable) to be accessed and an access method (reading in this example) to the control section 22b. Then, the access control section 22b refers to the access rule 221 to check the access right (Step S43). In this example, the access control section 22b returns the fact of being accessible (access OK) to the data access shared interface 23.

After the execution of the processing at Step S43, the data access shared interface 23 outputs a reading request of the initialization variable to the variable managing section 22a (Step S44). Then, the variable managing section 22a refers to the storing destination list 222 to judge that the storing destination of the initialization variable is the shared stored data 14a of the nonvolatile memory 14, and reads the variable from the cache 13c in the RAM 13 (Step S45).

After the execution of the processing at Step S45, because the variable read from the cache 13c is not initialized, the data (the same variable as the one read from the cache 13c) is read from the shared stored data 14a to be written into the cache 13c (Step S46). The variable written into the cache 13c corresponds to an initialization variable. Then, the data access shared interface 23 informs the exclusive control managing section 22c of the end of the exclusive control of the initialization variable (Step S47). Then, the sensor processing module 19 restarts its processing stopped by the processing at Step S42 (Step S48). After the execution of the processing at Step S47, the initialization processing ends

As described above, according to the present embodiment, because each user module accesses shared data through data access shared interface 23 and the shared variable managing module 22, each user module does not mutually directly refer to and update the shared data. Consequently, because modification, replacement, addition, and the like can be easily performed in each module, the maintenance property of each module can be improved.

Moreover, because each user module does not mutually directly refer to and update shared data, the development of a user module can be performed without considering the influences to the other user modules. Consequently, the development of user modules can be parallely performed, and the shortening of the development period can be achieved (the development efficiency of a module can be improved).

To put it concretely, because the relation between modules is only the reading and the writing of data, when appropriate shared data (for example, the shared data to be used by the communication module 20) exists in the shared variable group 13b or the cache 13c, the development of the user module using the shared data (for example, the operation check of the communication module 20) can be performed. When it is needed to change shared data, the requirement can be dealt with by producing a simplified user module having only the function of changing the shared data suitably to write the changed shared data.

Moreover, the data access shared interface 23 obtains trigger information from the outside through the connection interfaces 18, or can obtain trigger information from a user module by the spontaneous output of the trigger information by the user module.

Moreover, because the exclusive control managing section 22c automatically performs the exclusive control of shared data at the time of the access to the shared data, a developer can safely access the shared data only by writing the code of accessing the shared data. Moreover, the access control section 22b restricts the access to shared data from each user module, and consequently unrighteous access can be detected. Consequently, it is useful, for example, at the time of obtaining safety integrity level (SIL) authentication for safety ensuring of operations.

Moreover, by using a tool for setting the storing destination list 222 and the access rule 221, the field device 1 becomes strong on the exclusion of human mistakes and repetitive jobs to make it possible to decrease development man-hours.

### Modification of First Embodiment

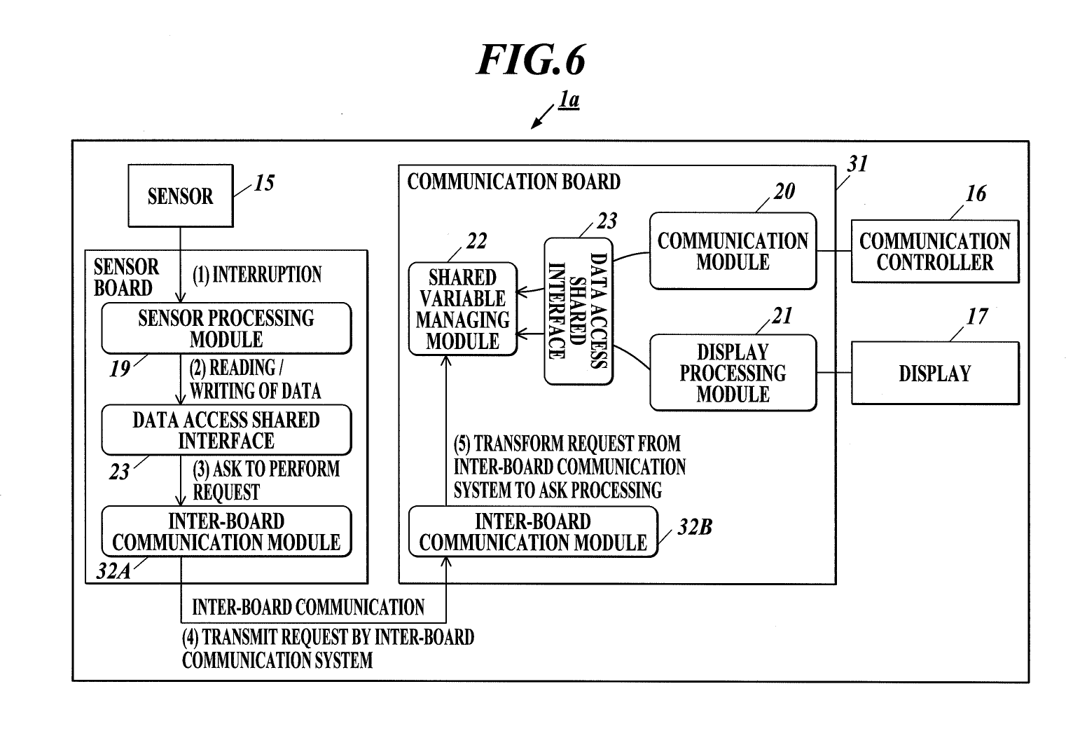

A modification of the first embodiment of the present invention will be described with reference to FIG. 6. FIG. 6 shows the configuration of the field device 1a of the present modification. In the following, the components similar to those of the field device 1 shown in FIG. 1 are denoted by the same reference marks, and their detailed descriptions are quoted herein. The components different from those of the field device 1 are chiefly described here.

The field device 1a includes a sensor board 30 and a communication board 31. The sensor board 30 is a board taking charge of sensing. The sensor board 30 includes the sensor processing module 19, the data access shared interface 23, and an inter-board communication module 32A. The inter-board communication module 32A is a module for performing communication with the communication board 31.

The communication board 31 is a board to take charge of communication and display. The communication board 31 includes the communication module 20, the display processing module 21, the shared variable managing module 22, the data access shared interface 23, and an inter-board communication module 32B. The inter-board communication module 32B is a module for performing the communication with the sensor board 30.

Next, the operation of the field device 1a shown in FIG. 6 will be described.

First, the sensor processing module 19 of the sensor board 30 receives an interruption from the sensor 15 (FIGS. 6-(1)). Then, the sensor processing module 19 transmits a reading/writing request of data to the data access shared interface 23 (FIGS. 6-(2)). Then, the data access shared interface 23 requests the reading/writing of data to the inter-board communication module 32A (FIGS. 6-(3)). Then, the reading/writing request of data is transformed by the inter-board communication system. Then, the inter-board communication module 32A transmits a reading/writing request of the data of the transformed communication system to the inter-board communication module 32B (FIGS. 6-(4)). Then, the reading/writing request of the data is transformed to the system before the transformation of the inter-board communication system. Then, the transformed reading/writing request of the data is requested to the shared variable managing module 22 (FIGS. 6-(5)).

As described above, according to the present modification, the data access shared interface 23 is shared by the pieces of hardware (sensor board 30 and communication board 31). By this configuration, a developer can share data without being conscious of the boundary of the pieces of hardware. Consequently, it becomes easy to adopt a multiprocessor or the like to enable the improvement of the degree of freedom of system design. Moreover, the functions operating in each board (sensor board 30 and communication board 31) decreases to make it possible to achieve the simplification of design.

### Second Embodiment

The above-stated first embodiment and the modification of the first embodiment share shared data (for example, a shared variable) by a plurality of user modules, and each user module reads and writes (accesses) the shared variable by the use of a common interface (data access shared interface 23). At this time, for example, in the case where the sensor processing module 19 and the display processing module 21 refer to (share) a certain shared variable, even when the sensor processing module 19 updates the shared variable, the display processing module 21 cannot know the update of the shared variable. In order that the display processing module 21 may ascertain the update of the shared variable, it is needed that the display processing module 21 itself periodically ascertains the content of the shared variable. In this case, a time lag arises between the update of the shared variable by the sensor processing module 19 and the recognition (ascertainment) of the update by the display processing module 21, and a problem of the occurrence of the hindrance of the linking between user modules. Moreover, in this case, the display processing module 21 is required to periodically perform update ascertainment even when the shared variable is not updated, and there is the problem of lowering the processing efficiency of the whole software.

Moreover, in the above-stated first embodiment and the modification of the first embodiment, even when an error arises in the update of a shared variable when a plurality of shared variables is updated at the same time, the other shared variables are updated. Consequently, the first embodiment and the modification thereof have the problem that it is impossible to guarantee the simultaneity of updates of a plurality of shared variables in the case where the plurality of shared variables is significant when the shared variables are coupled to a set, such as a measured value and the status thereof.

In order to solver the above-stated problems, in the present embodiment, a description will be given to a field device 2 having the function of informing all the user modules referring to shared data of the information indicating an update of the shared data, updated data indicating the updated shared data, and a variable identifier indicating the identifier of the updated shared data. In the following, the three elements (the information indicating the update of the shared data, the updated data indicating the updated shared data, and the variable identifier indicating the identifier of the updated shared data) will be collectively referred to as an update event. Moreover, the description will be given on the supposition that the shared data to be updated is a shared variable.

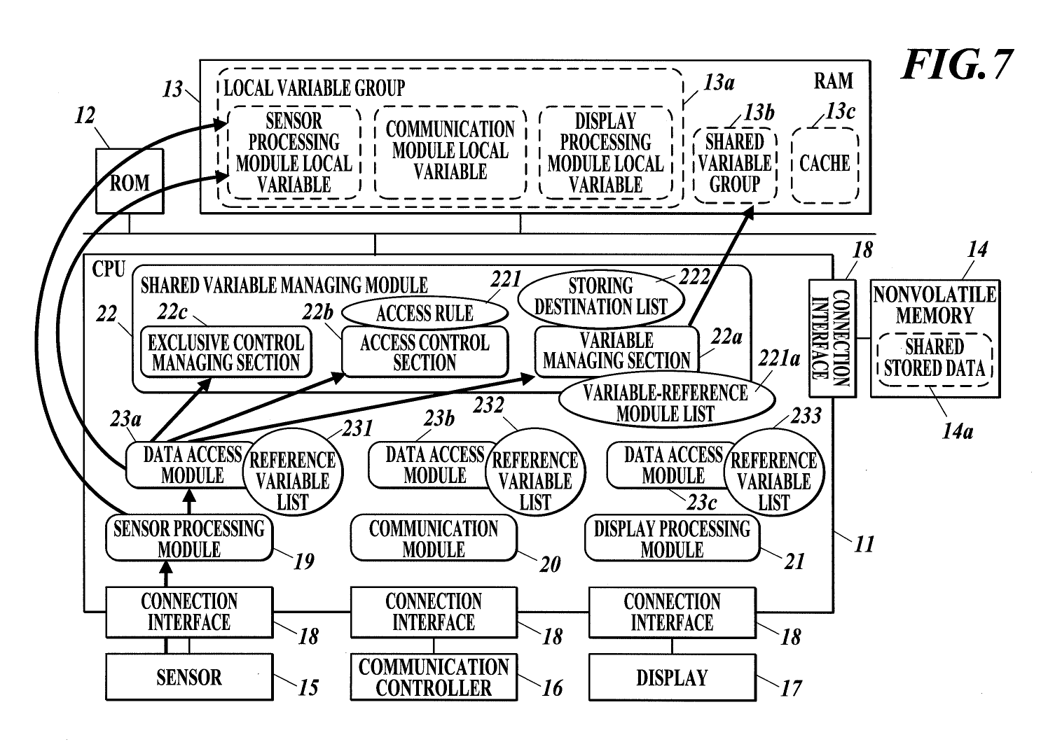

First, the configuration of the field device 2 of the present embodiment will be described with reference to FIG. 7. In the following, the components similar to those of the field device 1 shown in FIG. 1 are denoted by the same reference marks as those of the field device 1, and the detailed descriptions of the components of the field device 1 are quoted. Then, the components different from those of the field device 1 will be chiefly described.

As shown in FIG. 7, the CPU 11 of the field device 2 includes the sensor processing module 19, the communication module 20, the display processing module 21, the shared variable managing module 22 as a control section, and data access modules 23a, 23b, and 23c as interface sections. Incidentally, the arrows in FIG. 7 show examples of the flows of information.

When a shared variable is updated, the variable managing section 22a of the shared variable managing module 22 informs the data access modules for user modules referring to the same shared variable of the update event in accordance with a variable-reference module list 221a.

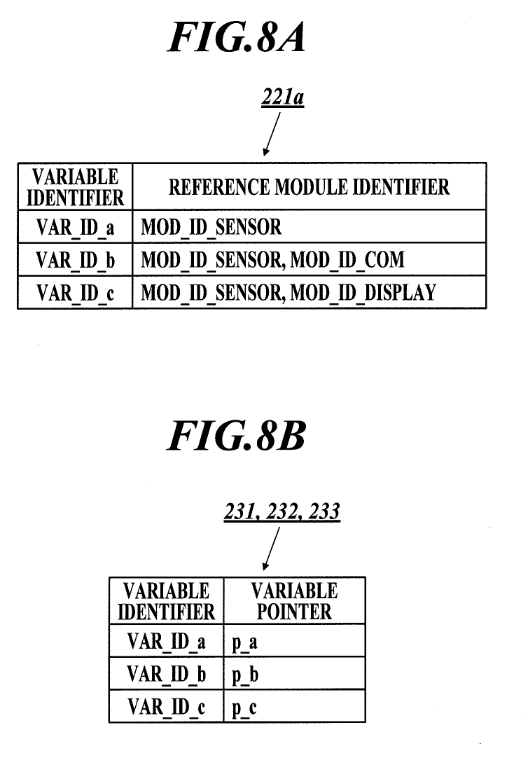

Here, an example of the variable-reference module list 221a will be described with reference to FIG. 8A. The variable-reference module list 221a is stored in the RAM 13. As shown in FIG. 8A, the variable-reference module list 221a includes variable identifiers as the identifiers of shared data, and reference module identifiers as the identifiers of user modules, and stores the variable identifiers and the reference module identifiers in the state of being associated with each other. The variable identifiers indicate the identifiers of the updated shared variables. The reference module identifiers indicate the identifiers of the user modules to refer to the updated shared variables. For example, when a plurality of user modules shares one shared variable, the plurality of module identifiers is stored in the variable-reference module list 221a to be associated with the one variable identifier.

Moreover, the variable identifiers and the module identifiers in the variable-reference module list 221a are registered into the variable-reference module list 221a by the variable managing section 22a when respective data access modules 23a-23c access the variable managing section 22a.

When a shared variable is updated, the variable managing section 22a reads the variable-reference module list 221a from the RAM 13 to refer to the user modules so as to select the user module associated with the updated shared variable on the basis of the read variable-reference module list 221a. Then, the variable managing section 22a informs the selected user module of an update event through a data access module (the data access module for the selected user module). Moreover, when a plurality of user modules is selected, the variable managing section 22a informs the plurality of user modules of the update event. At this time, the variable managing section 22a does not inform the user module of the request source of the update event.

Moreover, when the variable managing section 22a simultaneously updates a plurality of shared variables and a roll back flag is ON, the variable managing section 22a reads and holds the data to be updated from the shared variable group 13b, and after that, the variable managing section 22a writes the data requested into the shared variable group 13b. After the ascertainment of the success of all of the updates, the variable managing section 22a informs the update event. Here, the roll back flag is a flag indicating whether to restore the shared variable stored in the shared variable group 13b to the shared variable before the update at the time of the failure of updating the shared variable or not.

Moreover, when the variable managing section 22a simultaneously updates a plurality of shared variables and the roll back flag is ON, and when the variable managing section 22a ascertains the failure of the updating of at least one shared variable among the plurality of shared variables, the variable managing section 22a restores the shared variable stored in the shared variable group 13b to the shared data before the update.

Each of the data access modules 23a-23c has the interface function of mediating between each user module and the shared variable managing module 22. The data access module 23a is a data access module for the sensor processing module 19. The data access module 23b is a data access module for the communication module 20. The data access module 23c is a data access module for the display processing module 21.

To put it concretely, each of the data access modules 23a-23c receives the variable identifier of a shared variable the update event of which each user module tries to receive (tries to refer to) and the variable pointer storing the shared variable thereof from each user module. Here, the variable pointer indicates an address in the local variable group 13a in the RAM 13.

Moreover, each of the data access modules 23a-23c receives an update event informed from the variable managing section 22a of the shared variable managing module 22 at the time of updating the shared variable, and transmits the received update event to each user module.

Moreover, when each of the data access modules 23a-23c receives an update event, the data access modules 23a-23c read reference variable lists 231-233, respectively, from the RAM 13, and severally copy the updated shared variable to the variable pointer associated with the updated shared variable on the basis of the read reference variable lists 231-233.

Here, an example of the reference variable lists 231-233 will be described with reference to FIG. 8B. The reference variable lists 231-233 are stored in the RAM 13. As shown in FIG. 8B, each of the reference variable lists 231-233 includes variable identifiers and variable pointers, and the variable identifiers and the variable pointers are stored in the state of being associated with each other. The variable identifiers and the variable pointers in each of the reference variable lists 231-233 are registered into the reference variable lists 231-233 by the respective data access modules 23a-23c when each of the variable identifiers and the variable pointers is received by each of the data access modules 23a-23c from each user module.

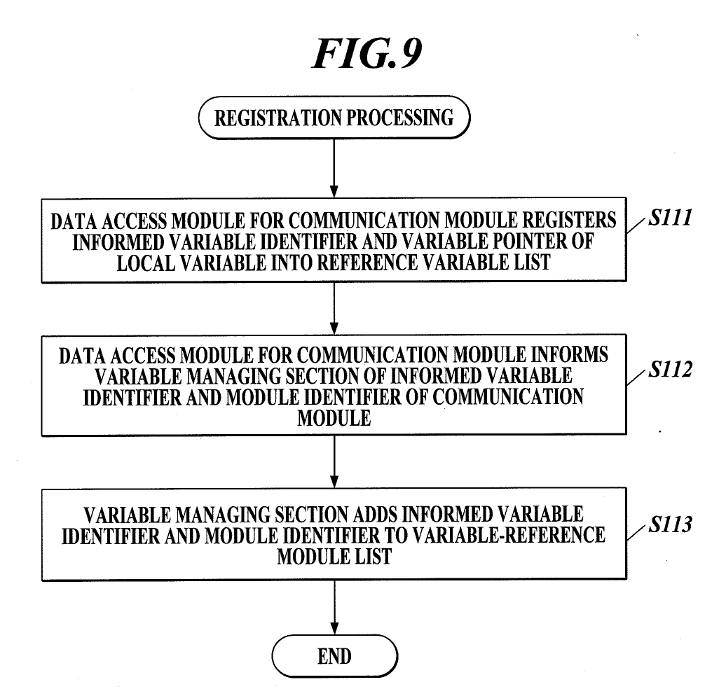

Next, the operation of the field device 2 will be described with reference to FIGS. 9-15. In the following, the operation of informing an update event to the communication module 20 that is referring to the same shared variable when the sensor processing module 19 updates the shared variable will be described.

First, registration processing will be described with reference to FIG. 9. The registration processing is the processing of registering a variable identifier and a variable pointer into the reference variable list 232 in the communication module 20.

For example, the registration processing is executed with the cooperation between the registration program, which is read from the ROM 12 and is suitably expanded in the RAM 13, and the CPU 11 by the transmission of the variable identifier of a shared variable the update event of which the communication module 20 of the field device 2 tries to obtain (tries to receive the update event) and the variable pointer of the shared variable from the communication module 20 to the data access module for 23b for the communication module 20 (hereinafter referred to as the data access module 23b) as a trigger.

First, the data access module 23b registers the variable identifier and the variable pointer that have been informed from the communication module 20 into the reference variable list 232 (Step S111). For example, when the informed variable identifier is “VAR_ID_b,” and the pointer is “p_b,” the data access module 23b registers the variable identifier “VAR_ID b” and the pointer “p_b” into the reference variable list 232.

Then, the data access module 23b informs the variable managing section 22a of the variable identifier informed from the communication module 20 and the module identifier of the communication module 20 (Step S112). For example, the data access module 23b informs the variable managing section 22a of the variable identifier “VAR_ID_b” and the module identifier “MOD_ID_COM” of the communication module 20.

After the execution of the processing at Step S112, the variable managing section 22a adds the variable identifier and the module identifier which have been informed from the data access module 23b to the variable-reference module list 221a (Step S113). After the execution of the processing at Step S113, the registration processing ends.

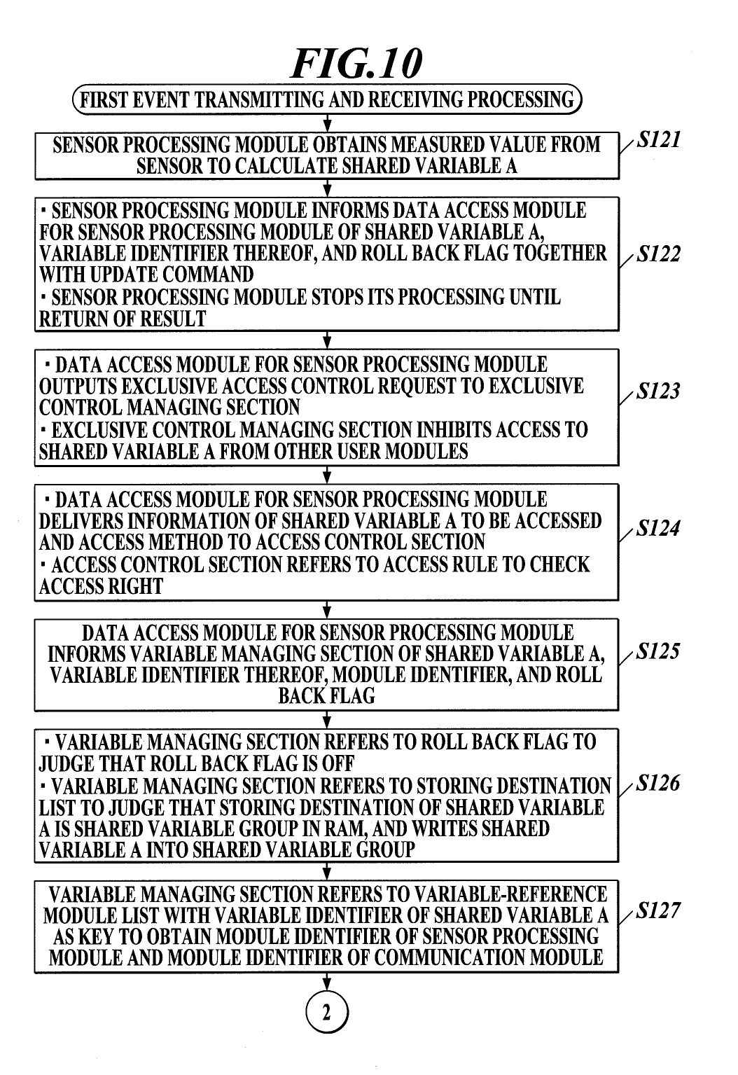

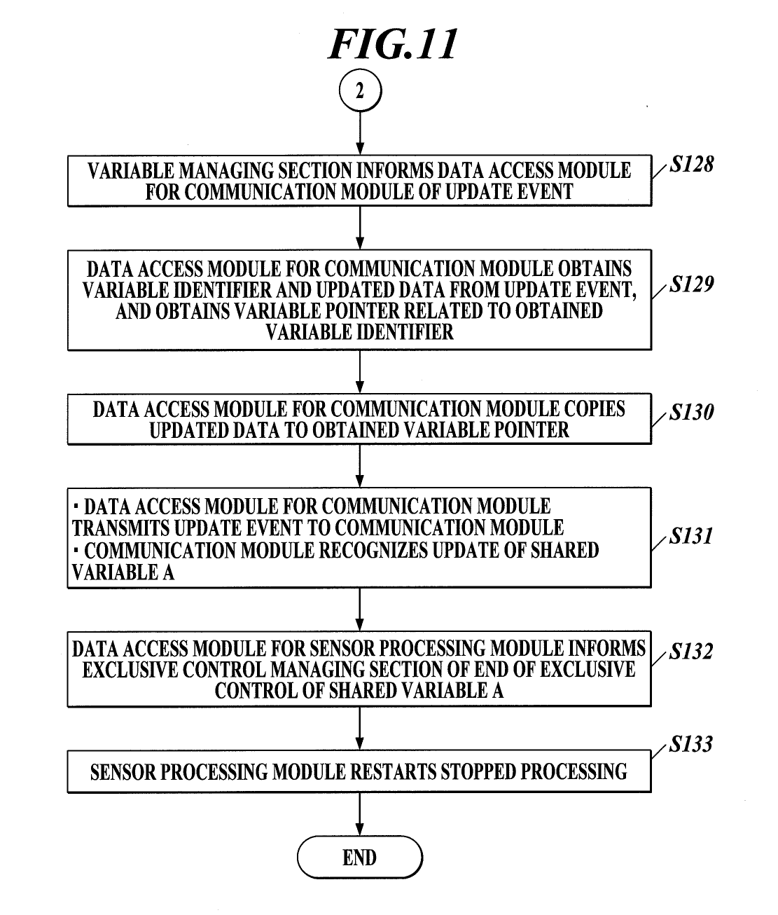

Next, first event transmitting and receiving processing will be described with reference to FIGS. 10 and 11. The first event transmitting and receiving processing is the processing of requesting the update of the shared variable A by the sensor processing module 19 to the variable managing section 22a by setting the roll back flag to OFF, and informing the communication module 20 of the update event when the update of the shared variable A by the variable managing section 22a has succeeded.

It is supposed that the shared variable A has been held (stored) in the shared variable group 13b in the RAM 13 in advance. Moreover, it is supposed that the reading and the writing of the shared variable A from the sensor processing module 19 are permitted.

Moreover, it is supposed that the sensor processing module 19 and the communication module 20 are set as the modules for referring to the shared variable A. To put it concretely, for example, it is supposed that the variable identifier “VAR_ID_b” of the shared variable A and the module identifier (the module identifier “MOD_ID_SENSOR” of the sensor processing module 19 and the module identifier “MOD_ID_COM” of the communication module 20) are stored in the variable-reference module list 221a in the state of being associated with each other.

Moreover, for example, it is supposed that the variable identifier “VAR_ID_b” of the shared variable A and the pointer “p_b” are stored in the reference variable list 232 in the state of being associated with each other.

Moreover, it is supposed that the roll back flag is set to OFF.

For example, in the field device 2, the first event transmitting and receiving processing is executed with the cooperation between a first event transmitting and receiving program, which is read from the ROM 12 and is suitably expanded in the RAM 13, and the CPU 11 by the reception of an interruption (the interruption indicating the preparation of a measured value in the sensor 15) from the sensor 15 by the connection interface 18 and the entering of the received interruption into the sensor processing module 19 as a trigger.

First, the sensor processing module 19 obtains a measured value from the sensor 15, and calculates the shared variable A from the obtained measured value (Step S121). Then, the sensor processing module 19 informs (outputs) the data access module 23a for the sensor processing module 19 of the shared variable A, the variable identifier of the shared variable A, and the roll back flag together with an update command. Here, the sensor processing module 19 stops its processing until the return of a result (Step S122).

After the execution of the processing at Step S122, in order to access the shared variable A, the data access module 23a for the sensor processing module 19 (hereinafter referred to as the data access module 23a) outputs an exclusive access control request to the exclusive control managing section 22c. Then, the exclusive control managing section 22c inhibits the shared variable A from being accessed from the other user modules (Step S123).

Then, the data access module 23a delivers the information of the shared data (shared variable A) to be accessed and the access method (writing) thereto to the access control section 22b. Then, the access control section 22b refers to the access rule 221 to check the access right thereto (Step S124). In this example, the control section 22b returns the answer of being accessible (access OK) to the data access module 23a.

After the execution of the processing at Step S124, the data access module 23a informs the variable managing section 22a of the shared variable A, the variable identifier of the shared variable A, the module identifier, and the roll back flag (Step S125).

After the execution of the processing at Step S125, the variable managing section 22a refers to the roll back flag to judges that the roll back flag is OFF. That is, it is judged that data (shared variable A) is not restored (is not restored to the shared variable before the update) at the time of the failure of writing. Then, the variable managing section 22a refers to the storing destination list 222 to judge that the storing destination of the shared variable A is the shared variable group 13b in the RAM 13, and the variable managing section 22a writes the shared variable A into the shared variable group 13b (Step S126).

After the execution of the processing at Step S126, when the writing into the shared variable group 13b has succeeded, the variable managing section 22a refers to the variable-reference module list 221a with the variable identifier of the shared variable A as a key, and the variable managing section 22a obtains the module identifier of the sensor processing module 19 and the module identifier of the communication module 20 (Step S127). To put it concretely, the variable managing section 22a obtains the module identifier “MOD_ID_SENSOR” of the sensor processing module 19 and the module identifier “MOD_ID_COM” of the communication module 20.

After the execution of the processing at Step S127, the variable managing section 22a informs the data access module 23b for the communication module 20, which is not the writing request source (that is, the data access module 23a of the sensor processing module 19) of the update event (Step S128).

After the execution of the processing at Step S128, the data access module 23b obtains the variable identifier (the variable identifier “VAR_ID_b” of the updated shared variable A) and the updated data (updated shared variable A) on the basis of the update event. Then, the data access module 23b refers to the reference variable list 232 to obtain the variable pointer associated with the obtained updated data (Step S129). To put it concretely, the data access module 23b obtains the variable pointer “p_b” associated with the variable identifier “VAR_ID_b” of the updated shared variable A.

After the execution of the processing at Step S129, the data access module 23b copies the updated data (shared variable A) to the obtained variable pointer (Step S130).

After the execution of the processing at Step S130, the data access module 23b transmits the update event to the communication module 20. Then, the communication module 20 recognizes the update of the shared variable A (Step S131).

After the execution of the processing at Step S131, the data access module 23a informs the exclusive control managing section 22c of the end of the exclusive control of the shared variable A (Step S132). Then, the sensor processing module 19 restarts its processing stopped at the time of the execution of the processing at Step S122 (Step S133). After the execution of the processing at Step S133, the first event transmitting and receiving processing ends.

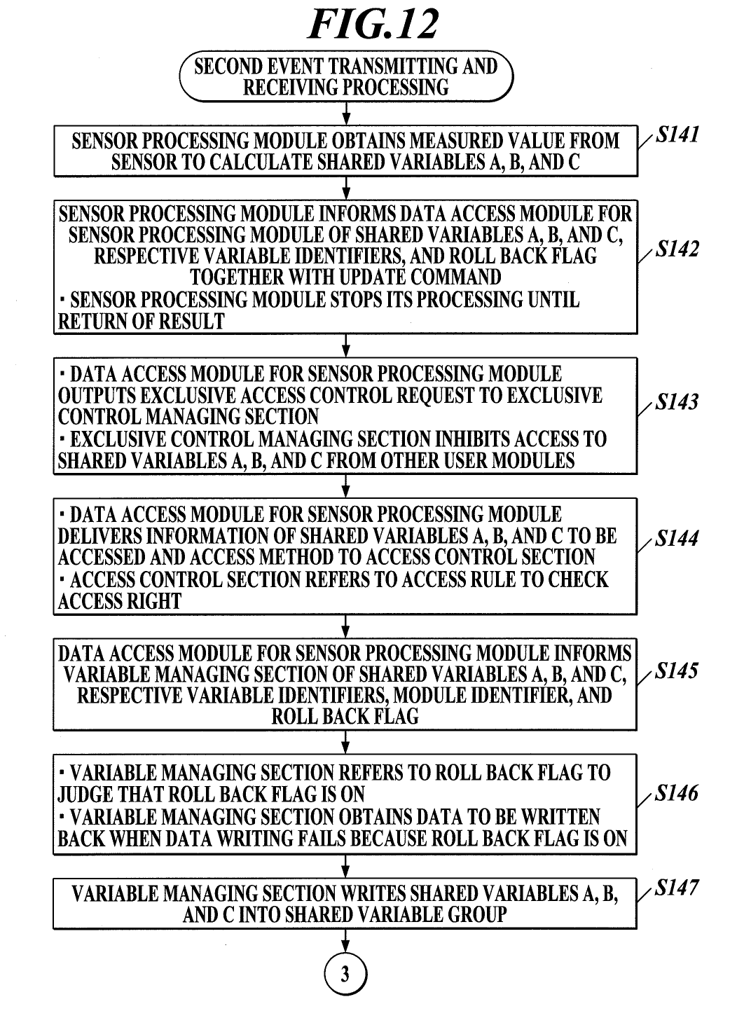

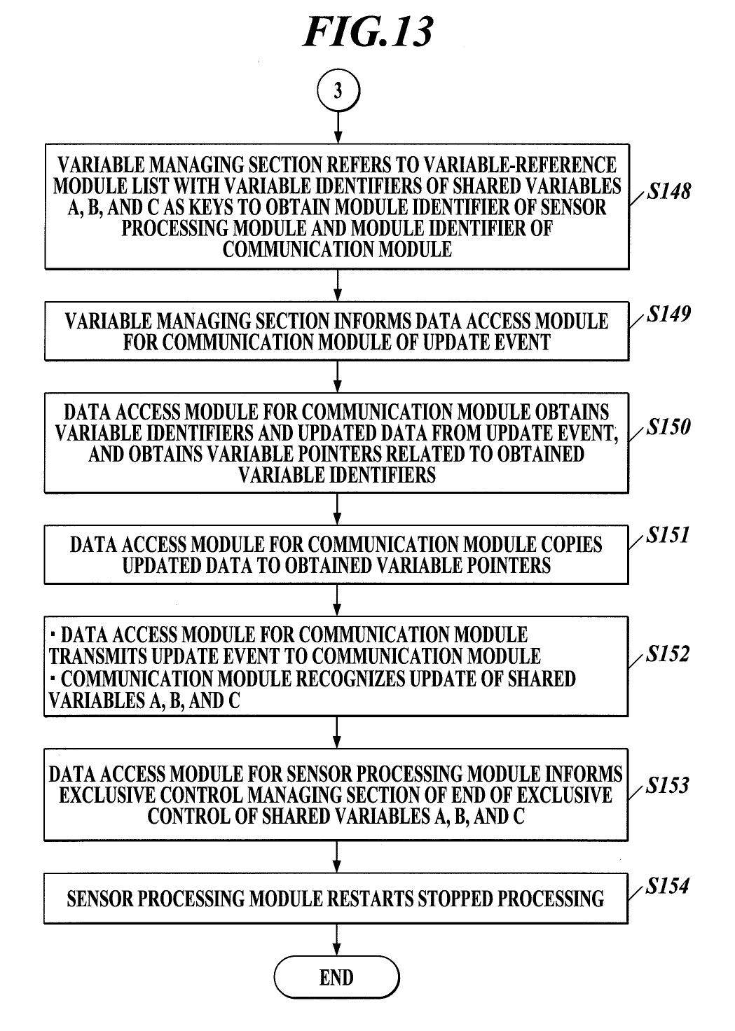

Next, a second event transmitting and receiving processing will be described with reference to FIGS. 12 and 13. The second event transmitting and receiving processing is the processing of requesting (informing) the variable managing section 22a to update a plurality of shared data (supposed to be shared variables A, B, and C) with the sensor processing module 19 by setting the roll back flag ON and informing the communication module 20 of the update event when the variable managing section 22a has succeeded the updates of the shared variables A, B, and C.

It is supposed that the shared variables A, B, and C are held (stored) in the shared variable group 13b in the RAM 13 in advance. Moreover, it is supposed that the reading and the writing of the shared variables A, B, and C from the sensor processing module 19 are permitted.

Moreover, it is supposed that the sensor processing module 19 and the communication module 20 are set as the modules of referring to the shared variables A, B, and C.

Moreover, it is supposed that the variable identifiers and the variable pointers of the shared variables A, B, and C are stored in the reference variable list 232 in the state of being associated with each other.

Moreover, it is supposed that the roll back flag is set to ON.

The trigger of the second event transmitting and receiving processing is similar to that of the first event transmitting and receiving processing.

The processing at Steps S141-145 is similar to the processing at Steps S121-125 in the first event transmitting and receiving processing. To put it concretely, the shared variable A of the first event transmitting and receiving processing is replaced with the shared variables A, B, and C, and then the processing at Step S141-145 is executed.

After the execution of the processing at Step S145, the variable managing section 22a refers to the roll back flag to judge that the roll back flag is ON. That is, the variable managing section 22a judges to restore the data (shared variables A, B, and C) to the original states (to restore the shared variables A, B, and C before the update) at the time of the failure of data writing. Then, the variable managing section 22a refers to the storing destination list 222 to judges that the storing destinations of the shared variables A, B, and C are in the shared variable group 13b in the RAM 13, and obtains the data (shared variables A, B, and C) to be written back at the time of the failure of data writing from the shared variable group 13b (Step S146). At this time, the obtained shared variables A, B, and C are the data before the updates and are written back into the share variable group 13b at the time of the failure of the writing of the shared variable A.

After the execution of the processing at Step S146, the variable managing section 22a writes the shared variables A, B, and C into the shared variable group 13b (Step S147).

The processing at Steps S148-Step S154 is similar to the processing at Steps S127-133 in the first event transmitting and receiving processing. To put it concretely, the shared variable A of the first event transmitting and receiving processing is replaced with the shared variables A, B, and C at the time of the execution of the processing at Steps S148-Step S154. After the execution of the processing at Step S154, the second event transmitting and receiving processing ends.

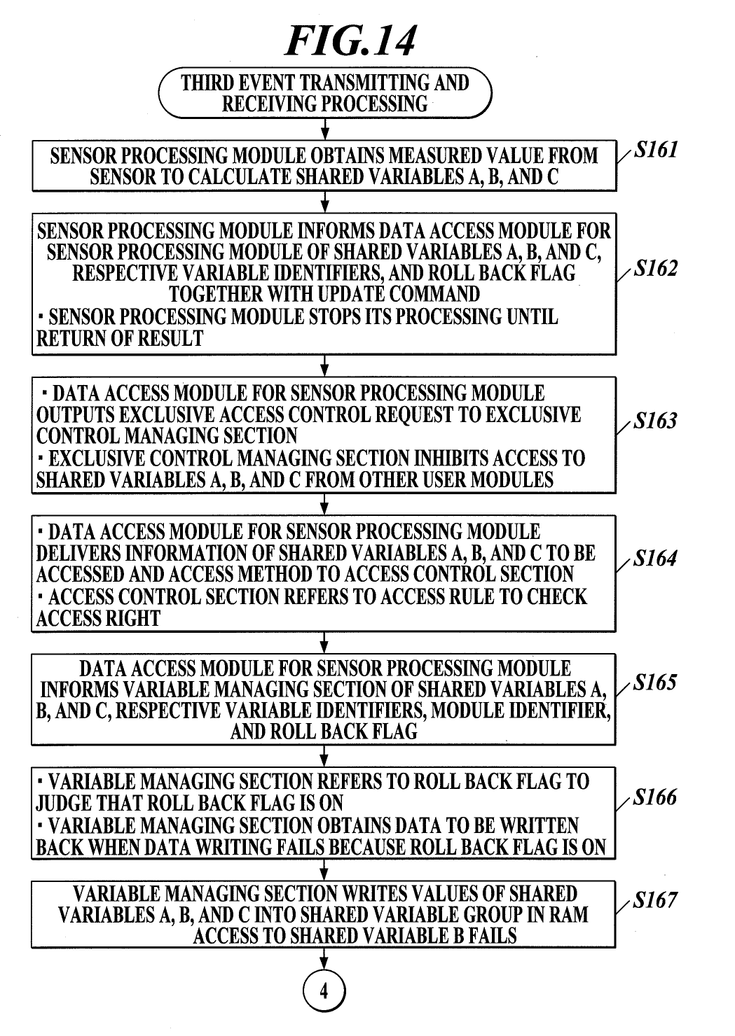

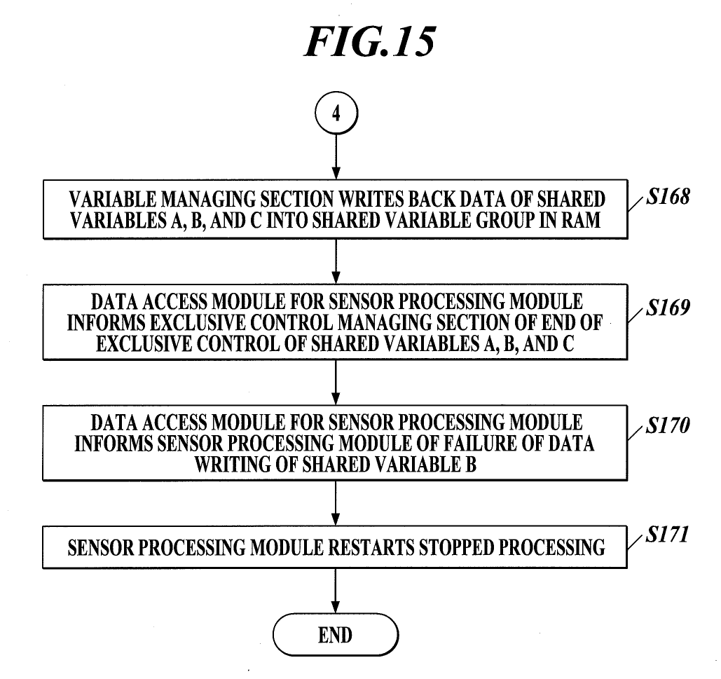

Next, a third event transmitting and receiving processing will be described with reference to FIGS. 14 and 15. The third event transmitting and receiving processing is the processing of requesting (informing) the variable managing section 22a to update a plurality of shared data (shared variables A, B, and C) by the sensor processing module 19 by setting the roll back flag to ON, and not performing the updates of the shared variables A, B, and C when the update of one of the shared variables A, B, and C by the variable managing section 22a has failed.

It is supposed that the shared variables A, B, and C have been held (stored) in the shared variable group 13b in the RAM 13 in advance. Moreover, it is supposed that the reading and the writing of the shared variables A, B, and C from the sensor processing module 19 are permitted.

Moreover, it is supposed that the sensor processing module 19 and the communication module 20 are set as the modules to refer to the shared variables A, B, and C.

Moreover, it is supposed that the variable identifiers and the variable pointers of the shared variables A, B, and C are stored in the reference variable list 232 in the state of being associated with each other.

Moreover, it is supposed that the roll back flag is set to ON.

The trigger of the third event transmitting and receiving processing is similar to that of the first event transmitting and receiving processing.

The processing at Steps S161-166 is similar to that at Steps S141-146 of the second event transmitting and receiving processing.

After the execution of the processing at Step S166, the variable managing section 22a writes the shared variables A, B, and C into the shared variable group 13b. At this time, the access of the shared variable B fails (writing fails) (Step S167). Moreover, in this case, the variable managing section 22a does not perform the access (writing) of the shared variable C, and does not inform any update events.

After the execution of the processing at Step S167, the variable managing section 22a writes back the data of the shared variables A, B, and C into the shared variable group 13b in the RAM 13 (Step S168).

After the execution of the processing at Step S168, the data access module 23a informs the exclusive control managing section 22c of the end of the exclusive control of the shared variables A, B, and C (Steps S169). Then, the data access module 23a informs the sensor processing module 19 of the failure of the data writing (Step S170). Then, the sensor processing module 19 restarts its processing (Step S171). After the execution of the processing at Step S171, the third event transmitting and receiving processing ends.

As described above, according to the present embodiment, when a shared variable is updated, an update event is informed to all the user modules referring to the shared variable. Consequently, because the periodic update ascertainment by the user modules becomes unnecessary, the possibility of the concentration of the accesses to a shared variable to the shared variable managing module 22 to make the shared variable managing module 22 a bottleneck can be reduced. Moreover, the time lag between an update of a shared variable and the transmission of the data (updated data) of the shared variable to another user module can be made to be small.

Moreover, the linking between user modules, such as the update of a certain shared variable by a certain user module and the recalculation of another piece of data interlocking with the updated shared variable by another user module, becomes easy. Moreover, each user module becomes unnecessary to perform the periodic ascertainment of the updates of shared variables, and the processing of each user module is simplified. Then, the performance of the processing of each user module can be improved.

Moreover, when even one of the updates fails when the update of a plurality of shared variables is performed, all of the requests are annulled, and the shared variables are restored to those before the updates. Consequently, in the case where a plurality of shared variables is significant only in a set, such as a measured value and the status thereof, the case in which only a part of the plurality of shared variables is updated is removed, and then the simultaneity of the shared variables is guaranteed. Moreover, it becomes unnecessary for the user modules to perform error checks and the processing of writing back the shared variables.

### Modification of Second Embodiment

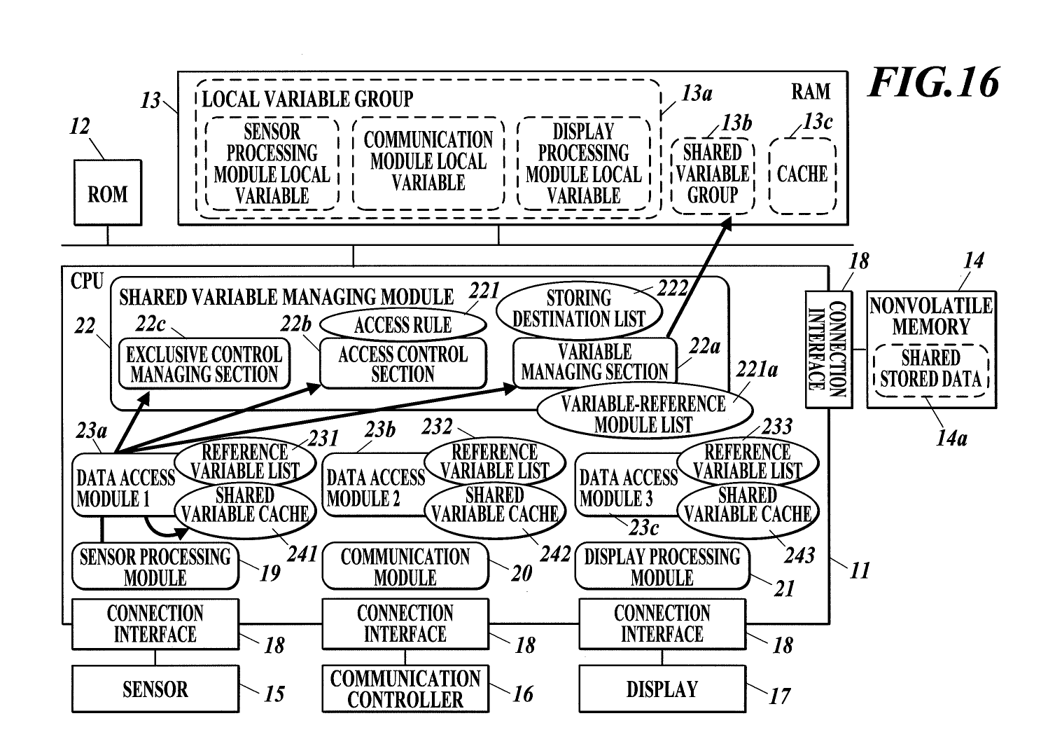

A modification of the second embodiment of the present invention will be described with reference to FIG. 16. FIG. 16 shows the configuration of a field device 2a of the present modification. In the following, the components similar to those of the field device 2 shown in FIG. 7 will be denoted by the same reference marks, and the detailed descriptions of the field device 2 will be quoted. Then, the components different from those of the field device 2 will be chiefly described.

The data access modules 23a-23c copy the shared variable A obtained at the time of the first reading of the shared variable to caches 241-243. Then, the data access modules 23a-23c reads the shared variable A copied to the shared variable caches 241-243 at the time of reading the shared variable A on and after the next time.

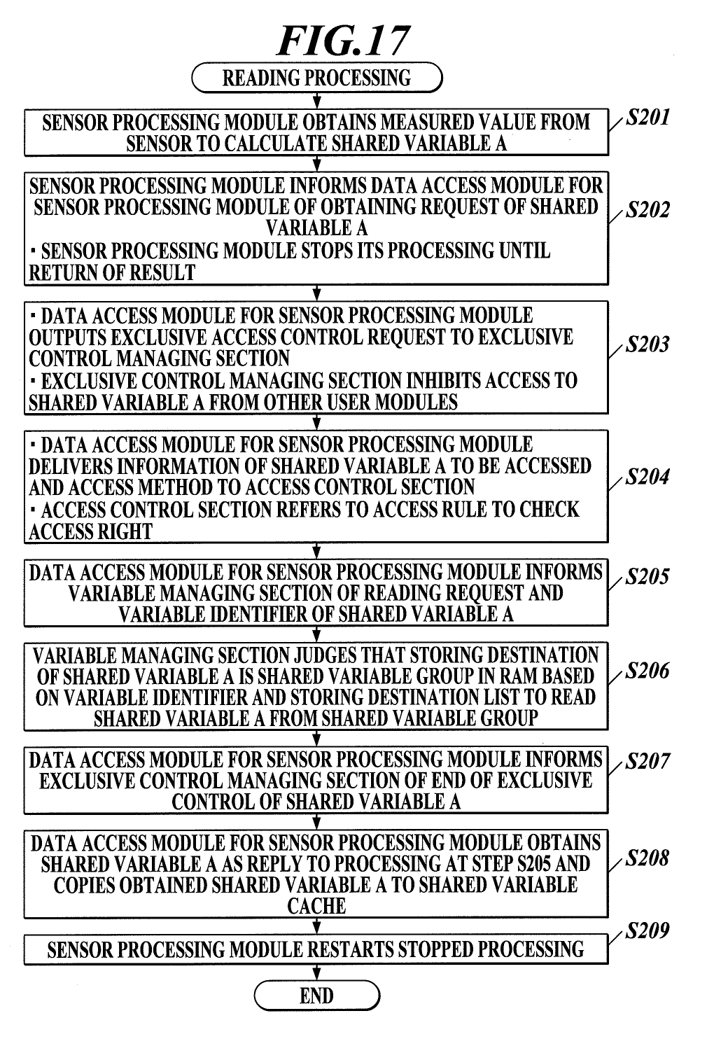

Next, the operation of the field device 2a will be described with reference to FIGS. 17-19. First, reading processing will be described with reference to FIG. 17. The reading processing is the processing of reading the shared variable A from the shared variable group 13b to copy the read shared variable A to the shared variable cache 241.

It is supposed that the shared variable A has been held (stored) in the shared variable group 13b in the RAM 13 in advance. Moreover, it is supposed that the reading and the writing of the shared variable A from the sensor processing module 19 are permitted.

The trigger of reading processing is similar to that of the first event transmitting and receiving processing.

First, the sensor processing module 19 obtains a measured value from the sensor 15, and calculates the shared variable A from the obtained measured value (Step S201). Then, the sensor processing module 19 informs (outputs) the data access module 23a of an obtaining (reading) request of the shared variable A. Here, the sensor processing module 19 stops its processing until the return of a result (Step S202).

After the execution of the processing at Step S202, in order to access the shared variable A, the data access module 23a outputs an exclusive access control request to the exclusive control managing section 22c. Then, the exclusive control managing section 22c inhibits the shared variable A from being accessed from the other user modules (Step S203).

Then, the data access module 23a delivers the information of the shared data (shared variable A) to be accessed and an access method (reading) to the access control section 22b. Then, the access control section 22b refers to the access rule 221 of the shared data to check an access right thereto (Step S204). In this example, the access control section 22b returns the answer of being accessible (access OK) to the data access module 23a.

After the execution of the processing at Step S204, the data access module 23a informs the variable managing section 22a of the shared variable A and the variable identifier of the shared variable A (Step S205).

After the execution of the processing at Step S205, the variable managing section 22a refers to the variable identifier and storing destination list 222 to judges that the storing destination of the shared variable A is the shared variable group 13b in the RAM 13, and reads the shared variable A from the shared variable group 13b (Step S206).

After the execution of the processing at Step S206, the data access module 23a informs the exclusive control managing section 22c of the end of the exclusive control of the shared variable A (Step S207). Then, the variable managing section 22a informs the data access module 23a of the read shared variable A. Then, the data access module 23a obtains the shared variable A as a reply of the processing at Step S205, and copies the obtained shared variable A to the shared variable cache 241 (Step S208). Then, the sensor processing module 19 restarts its stopped processing (Step S209). After the execution of the processing at Step S209, the reading processing ends.

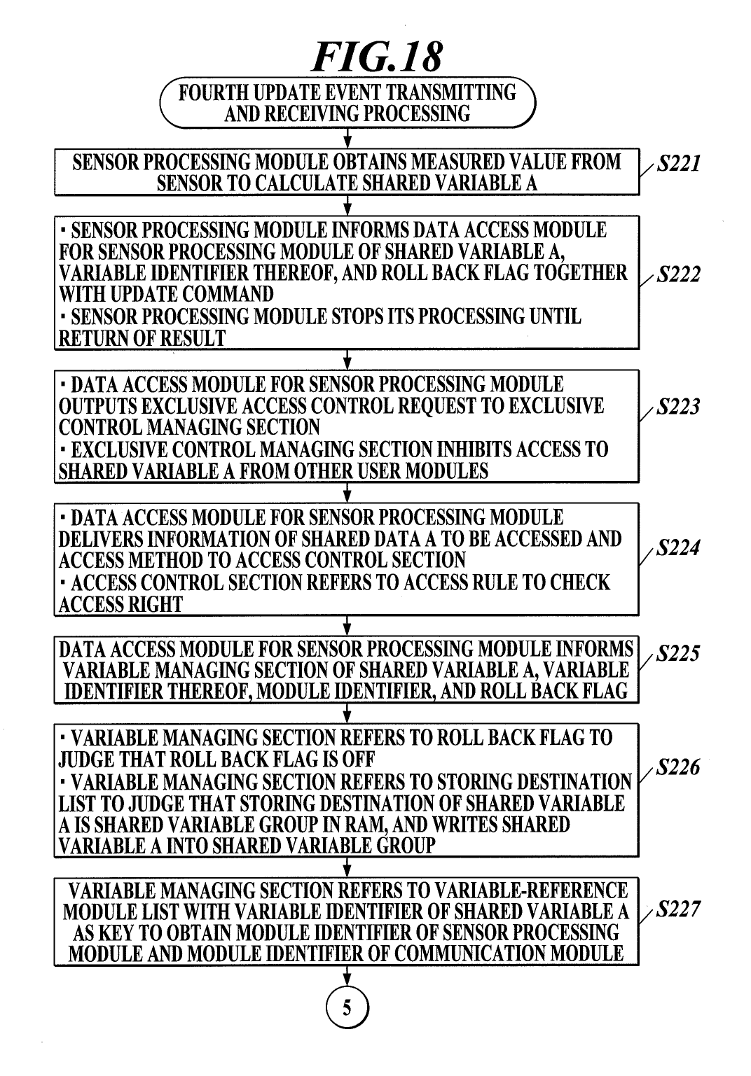

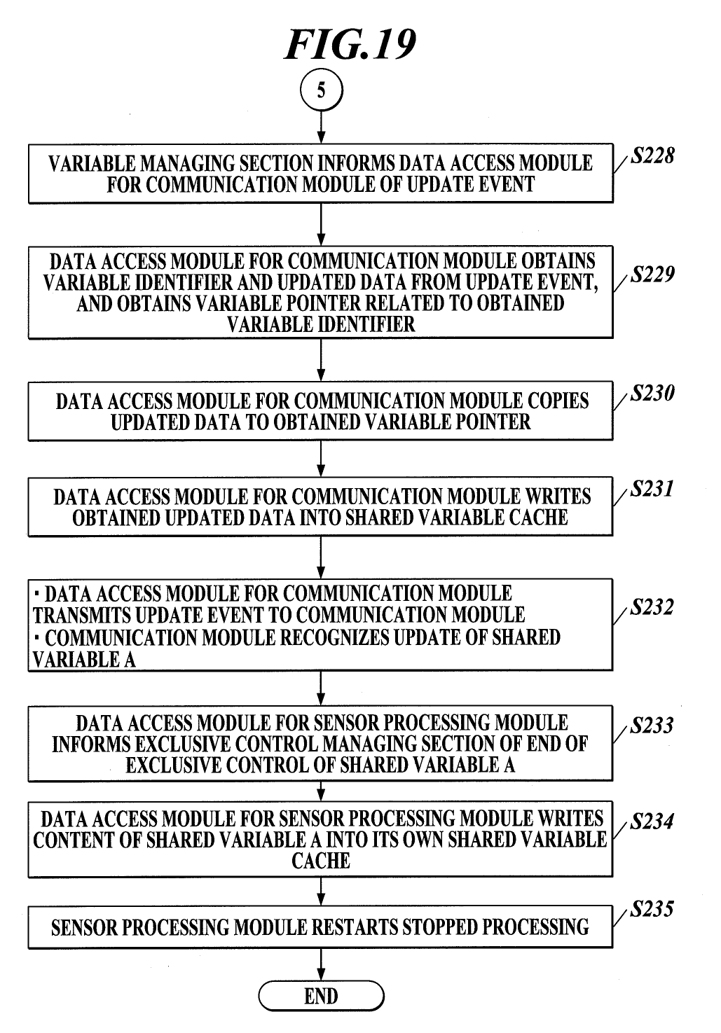

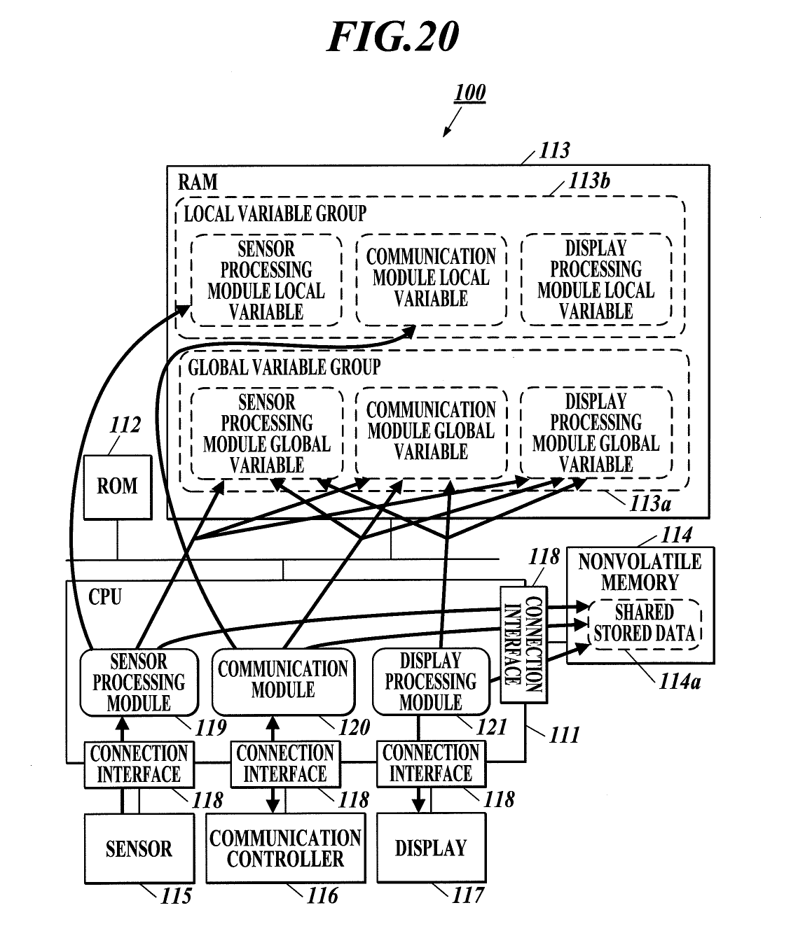

Next, a fourth update event transmitting and receiving processing will be described with reference to FIGS. 18 and 19. The fourth update event transmitting and receiving processing is the processing of requesting the update of the shared variable A by the sensor processing module 19 to the variable managing section 22a by setting the roll back flag to OFF, informing the communication module 20 of an update event when the update of the shared variable A by the variable managing section 22a has succeeded, and writing the updated shared variable A into the shared variable cache 242 on the basis of the informed update event.

The prior conditions and the trigger of processing in the fourth update event transmitting and receiving processing are similar to those of the first event transmitting and receiving processing.

In the fourth update event transmitting and receiving processing, the processing at Steps S221-S230 is similar to that at Steps S121-S130 in the first event transmitting and receiving processing.

After the execution of the processing at Step S230, the data access module 23b writes the obtained updated data (updated shared variable A) into the shared variable cache 242 (Step S231).

The processing at Steps S232 and S233 is similar to that at Steps S131 and S132 in the first event transmitting and receiving processing.

After the execution of the processing at Step S233, the data access module 23a writes the content of the shared variable A into its own shared variable cache 241 (Step S234). Then, the sensor processing module 19 restarts its stopped processing (Step S235). After the execution of the processing at Step S235, the fourth update event transmitting and receiving processing ends.

When the shared variable A is read again (in the case of reading on and after a second time) after the execution of the above-stated reading processing or the fourth update event transmitting and receiving processing, the data access modules 23a-23c read (access) the shared variable A stored in the shared variable caches 241-243, respectively.

As described above, according to the present modification, the data access modules 23a-23c access the shared variable A copied to the shared variable caches 241-243 at the time of reading the shared variable A again (on and after the second time). Consequently, because the data access modules 23a-23c do not need to access the shared variable managing module 22, the processing of the data access modules 23a-23c is simplified, and the performance of the processing of the data access modules 23a-23c can be improved.

Incidentally, the description of each of the embodiments and the modifications is an example of the field device according to the present invention, and the field device of the invention is not limited to the above description.

For example, although the shared variables stored in the shared variable group 13b have been described to be updated in the second embodiment and the modification of the second embodiment, the present invention is not limited this type of updates. For example, the similar processing may be performed when the cache data stored in the cache 13c and the shared stored data 14a are updated.

In addition, the minute structures and the minute operations of the field devices 1, 1a, 2, and 2a of the embodiments can be the suitably changed without departing from the spirit and scope of the present invention.

According to a first aspect of the preferred embodiments of the present invention, there is provided a field device comprising:

a storage section to store shared data which is shared between user modules;

an interface section to obtain trigger information to access the shared data, and to output access information which includes an access content of the shared data and an access request of the shared data, based on the obtained trigger information; and

a control section to access the shared data which is stored in the storage section, based on the access information which has been output by the interface section.

According to the first aspect of the present invention, the access to the shared data is performed on the basis of the access information. Consequently, the maintenance property and development efficiency of a module can be improved.

Preferably, the field device further comprises a communication section to perform a communication of information, wherein

the interface section obtains the trigger information from an outside through the communication section, or obtains the trigger information from the user module by an output of the trigger information which is performed spontaneously by the user module.

According to the second aspect of the present invention, the interface section can obtain the trigger information from the outside through the communication section, or can obtain the trigger information from the user module by the spontaneous output of the trigger information by the user module.

Preferably, the interface section outputs an exclusive access control request of the shared data, based on the trigger information, and wherein

the control section comprises:
an exclusive control managing section to perform an exclusive control of the shared data, based on the exclusive access control request;
an access control section to refer to an access rule in which an access right to the shared data is described, and to judge whether the accessing to the shared data is possible or not, based on the access content; and
a shared data managing section to refer to a storing destination list in which a storage area of the storage section where the shared data is stored is described, and to access the shared data which is stored in the storage area described in the storing destination list, based on the access request.

According to the third aspect of the present invention, the exclusive control managing section automatically performs the exclusive control of the shared data at the time of performing access to the shared data, and consequently a user (developer) can access the shared data safely only by writing the code for accessing the shared data. Moreover, the access control section restricts the access to the shared data from each of the user modules, and consequently unrighteous access can be detected.

Preferably, the access rule and the storing destination list are automatically generated based on a shared data name set by a developer, information which indicates an access method, and volatile information.

According to the fourth aspect of the present invention, the access rule and the storing destination list are automatically generated on the basis of a variable name set by a developer, the information indicating the access method information, and the volatile information, and consequently the field device becomes strong on the exclusion of human mistakes and repetitive jobs to make it possible to decrease development man-hours.

Preferably, when the shared data is updated, the control section refers to the user modules to select the user module which corresponds to the updated shared data, and informs the selected user module of an update event which indicates that the shared data has been updated through the interface section, based on a module list in which an identifier of the shared data and an identifier of the user module which refers to the shared data correspond to each other.

According to the fifth aspect of the present invention, the periodic update ascertainment by the user module becomes unnecessary, and consequently the possibility of the concentration of the access to the shared variable to the shared variable managing module to make the shared variable managing module a bottleneck can be decreased. Moreover, a time lag between the update of a shared variable and the transmission of the data (updated data) of the shared variable to another user module can be decreased.

Moreover, the linking between user modules, such as an update of a certain shared variable by a user module and a recalculation of other data interlocking with the shared variable by another user module, becomes easy.

Moreover, it becomes unnecessary to perform the ascertainment of the periodic update of a shared variable by each user module, and consequently the processing of each user module is simplified to enable the processing performance of each user module can be improved.

Preferably, when a plurality of pieces the shared data are to be updated simultaneously, the control section confirms whether all of the plurality of pieces of the shared data to be updated are updated correctly, and when the control section confirms that at least one piece of the shared data among the plurality of pieces of the shared data has failed to be updated, the control section restores the shared data which is stored in the storage section to the shared data before being updated.

According to the sixth aspect of the present invention, the case in which only a part of a plurality of shared variables is updated in the case where the plurality of shared variables is significant in the state of being a set, such as a measured value and the status thereof, is not caused, and the simultaneity of the shared variables is guaranteed. Moreover, it becomes unnecessary for each of the user modules to perform any error checks and the processing of writing back of a shared variable.

Preferably, the interface section copies the shared data obtained when the shared data has been accessed, to a shared variable cache, and accesses the shared data which is copied to the shared variable cache when the shared data is accessed for a second time or later.

According to the seventh aspect of the present invention, the processing of the interface section is simplified, and the performance of the processing of the interface section can be improved.

The entire disclosure of Japanese Patent Application No. 2008-260636 filed on Oct. 7, 2008, and Japanese Patent Application No. 2009-058883 filed on Mar. 12, 2009 including description, claims, drawings, and abstract are incorporated herein by reference in its entirety.

Although an exemplary embodiment has been shown and described, the invention is not limited to the embodiment shown. Therefore, the scope of the invention is intended to be limited solely by the scope of the claims that follow.

What is claimed is:

1. A field device comprising:
a storage section to store shared data which is shared between user modules;
an interface section to obtain trigger information to access the shared data, and to output access information which includes an access content of the shared data and an access request of the shared data, based on the obtained trigger information; and
a control section to access the shared data which is stored in the storage section, based on the access information which has been output by the interface section.

2. The field device according to claim 1, further comprising a communication section to perform a communication of information, wherein
the interface section obtains the trigger information from an outside through the communication section, or obtains the trigger information from the user module by an output of the trigger information which is performed spontaneously by the user module.

3. The field device according to claim 1, wherein the interface section outputs an exclusive access control request of the shared data, based on the trigger information, and wherein
the control section comprises:
an exclusive control managing section to perform an exclusive control of the shared data, based on the exclusive access control request;
an access control section to refer to an access rule in which an access right to the shared data is described, and to judge whether the accessing to the shared data is possible or not, based on the access content; and
a shared data managing section to refer to a storing destination list in which a storage area of the storage section where the shared data is stored is described, and to access the shared data which is stored in the storage area described in the storing destination list, based on the access request.

4. The field device according to claim 3, wherein the access rule and the storing destination list are automatically generated based on a shared data name set by a developer, information which indicates an access method, and volatile information.

5. The field device according to claim 1, wherein when the shared data is updated, the control section refers to the user modules to select the user module which corresponds to the updated shared data, and informs the selected user module of an update event which indicates that the shared data has been updated through the interface section, based on a module list in which an identifier of the shared data and an identifier of the user module which refers to the shared data correspond to each other.

6. The field device according to claim 1, wherein when a plurality of pieces the shared data are to be updated simultaneously, the control section confirms whether all of the plurality of pieces of the shared data to be updated are updated correctly, and when the control section confirms that at least one piece of the shared data among the plurality of pieces of the shared data has failed to be updated, the control section restores the shared data which is stored in the storage section to the shared data before being updated.

7. The field device according to claim 1, wherein the interface section copies the shared data obtained when the shared data has been accessed, to a shared variable cache, and accesses the shared data which is copied to the shared variable cache when the shared data is accessed for a second time or later.
